(19) United States
(12) Patent Application Publication
(10) Pub. No.: US 2017/0101849 A1
(43) Pub. Date: Apr. 13, 2017

(54) CHECK VALVE WITH VALVE MEMBER BIASED BY CONNECTORS EXTENDING FROM A VALVE SEAT

(71) Applicant: BAKER HUGHES INCORPORATED, Houston, TX (US)

(72) Inventor: Zachary S. Silva, Houston, TX (US)

(73) Assignee: BAKER HUGHES INCORPORATED, Houston, TX (US)

(21) Appl. No.: 14/880,991

(22) Filed: Oct. 12, 2015

(51) Int. Cl. E21B 34/10; E21B 43/116; F16K 15/02

(52) U.S. Cl. CPC E21B 34/10; F16K 15/021; E21B 43/116

(57) ABSTRACT

A check valve has a valve member flexibly attached to a seat with resilient members that fold in response to flow above a predetermined value to shut the valve. The flexibly extending members store potential energy that is released to separate the valve member from the seat when the pressure applied against the seated valve member declines to the point that the potential energy stored in the flexible members is able to move the valve member off the seat. The valve assembly including the valve member, the seat and the flexible members can be a common material, or can be all one or more nonmetallic materials or involve composites or other easily drilled materials that are compatible with the operating conditions of pressure differential, temperature and composition of the well fluid. The flexible members resist valve member rotation relative to a seat during milling.

### FIELD OF THE INVENTION

The field of the invention is check valves for subterranean use and more particularly check valves having a valve member supported by flexible members extending from a valve seat to regulate flow up to a predetermined level in a given direction before shutting off flow.

### BACKGROUND OF THE INVENTION

Check valves are used in a variety of subterranean applications. In some applications involving perforating and fracturing, a frack plug functions as a check valve in that it is normally opened for flow into the delivery string during running in. Once set the plug typically has a ball landed on a seat that prevents flow out through the plug. The perforating gun is positioned above the plug after the plug is set and fired to hopefully create perforations in the borehole. Pressure is applied from above the plug to seat the ball against a seat in the plug so that the pressure will be directed into the newly formed perforations to initiate fractures. This process is repeated in a bottom up direction until the entire wellbore is fractured. Prior to production the frack plugs are milled out and a production line and packer are run in for production from the fractured or treated zone.

Several issues have come up with check valves in frack plugs. One problem is that the ball rotates on the seat when the milling process is attempted. This relative rotation with respect to the valve seat delays the milling process because the ball winds up having to be eroded with rotation against the seat rather than just being milled through with the milling tool. Another problem with traditional ball checks occurs when the perforating gun fails to fire and must be removed and either redressed or replaced. Typically wells getting a plug and perforate treatment are highly deviated and require the use of flow from the surface to push a wireline supported gun to the desired location. This usually entails packer cups associated with the gun that stop the flow around the gun enough to fluidly power the gun to the desired location. The problem is that when the gun fails to perforate and the traditional check valve in the frack plug will not pass any fluid in a downhole direction, there is no way to use flow to deliver the replacement gun to the desired location.

A solution was earlier proposed by the inventor of the present invention in an application filed Apr. 23, 2015 in the US having a Ser. No. 14/694,350 where the ball for the frack plug is only delivered if the gun fires. This design entailed an acceleration sensitive locking system to drop the ball in response to the acceleration created when the gun was fired. This design addressed the problem of the gun not firing but not the issue of the difficulty in milling out a ball that spins on its ball seat during the milling process.

Spring loaded ball check valves with non-metallic components are shown in hydraulic systems in U.S. Pat. No. 5,454,399. Check valves with a ball captured for two directional free movement are shown in U.S. Pat. No. 5,785,083. Flow responsive valves to prevent blowouts are shown in U.S. Pat. No. 4,628,996. WO98/03766 shows in FIG. 8 a ball supported in a web in the seat opening that is responsive to flow. The support impedes flow due to its placement and is subject to erosion from fluid velocities due to placement in the seat opening.

The present invention addresses the issue of spinning when milling out, having to run in a replacement gun with no perforations, expediting the milling process and providing a way to get limited flow for gun redelivery with cutting off flow with larger flow rates in a simple design where components have multiple functionality to make the overall design simple and more amenable to reliable operation with nonmetallic material for expediting millout. These and other aspects of the present invention will be more readily apparent to those skilled in the art from a review of the description of the preferred embodiment and the associated drawings while recognizing that the full scope of the invention is to be found in the appended claims.

### SUMMARY OF THE INVENTION

A check valve has a valve member flexibly attached to a seat with resilient members that fold in response to flow above a predetermined value to shut the valve. The flexibly extending members store potential energy that is released to separate the valve member from the seat when the pressure applied against the seated valve member declines to the point that the potential energy stored in the flexible members is able to move the valve member off the seat. The valve assembly including the valve member, the seat and the flexible members can be a common material, or can be all one or more nonmetallic materials or involve composites or other easily drilled materials that are compatible with the operating conditions of pressure differential, temperature and composition of the well fluid. The flexible members resist valve member rotation relative to a seat during milling.

### BRIEF DESCRIPTION OF THE DRAWINGS

FIG. 1 is a section view through the valve with flow passing in a downhole direction when the flexible members keep the valve member off the seat;

FIG. 2 is the view of FIG. 1 with flow increased to the point of closing the valve.

### DETAILED DESCRIPTION OF THE PREFERRED EMBODIMENT

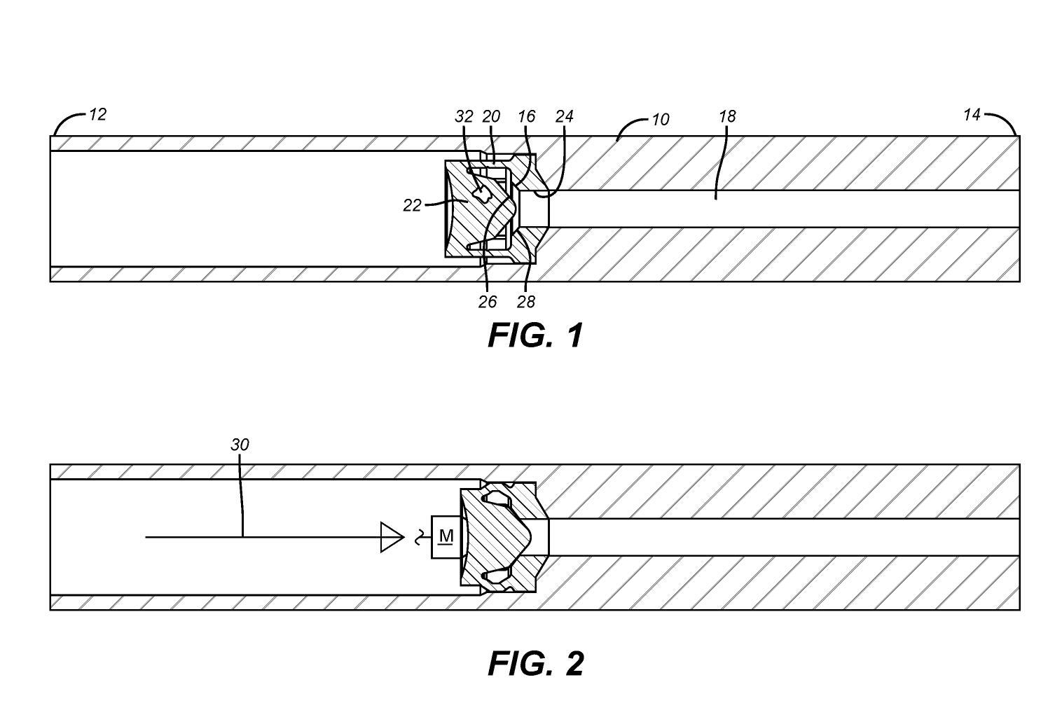

A frack plug body 10 has an uphole end 12 and a downhole end 14. A seat 16 surrounds outlet passage 18 and has a plurality of flexible extending members 20 to hold the valve member 22 spaced apart from opening 24 as shown in FIG. 1. The extending members 20 are also disposed peripherally of opening 24 to avoid constricting opening 24 while also keeping them away from the highest fluid velocities that are seen in opening 24. The valve member has a leading taper 26 that engages the sealing surface 28 as seen by comparing FIGS. 1 and 2. The components hold the relative positions in FIG. 1 when flow from end 12 toward end 14 is below a predetermined value. The number, dimensions and materials of construction of members 20 can be varied to obtain the desired flow rate below which valve member 22 is held away from the sealing surface 28. Typically this predetermined flow rate will approximate the pumped flow that interacts with peripheral seals on a wireline supported perforating gun that is not shown so that the replacement gun for a gun that failed to fire can be introduced and properly placed in a desired location in a reasonable time. Once the original or replacements guns fire, the flow rate from the surface in the direction of arrow can be increased moving the taper 26 against sealing surface 28 as shown in FIG. 2 for the valve closed position. Once that happens fracturing or other treatment can be forced into the perforations to create fractures or otherwise condition the formation for subsequent injection or production.

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc., all collectively included in a term “treating” as used herein. Another operation can be production from said zone or injection into said zone.

The use of the extending members 20 also resists relative rotation of the valve member 22 when milling it out with a mill schematically labeled as M. Limiting or eliminating relative rotation, depending on the design parameters and number of the extending members 20 will allow fast millout of the valve member 22.

The entirety of the valve assembly shown in FIGS. 1 and 2 can be made of a single material or multiple materials which are preferably non-metallic. Alternatively the sealing surface or the extending members 20 may be composites, dual compound elastomers or even metallic. Preferably the material for the valve member 22 is an elastomer. When using a single material for the entire assembly the preferred material is an elastomer or a relatively soft material for easy drilling out that can also withstand the high pressure differential from the treatment taking place in the FIG. 2 position above the valve and into the openings providing access to the formation. The extending members 20 are preferably short enough to collapse at a single location between sealing surface 28 and the mounting location to the valve member 22 although more than one flexing or folding location is also contemplated. The valve member preferably is larger than opening 24 to avoid entering it and getting stuck. However, the alignment of surfaces between the valve member 22 at its leading end facing the seat 16 can be varied. Instead of taper 26 the leading end of the valve member 22 can be flat or curved. The seat 16 can be secured to the body 10 with adhesive or with fasteners or locking sleeves preferably made of an easily drilled material. Optionally, internal voids or scores can be used to expedite the millout process with the understanding that the resulting part strength is adequate for holding the needed pressure differential in the no flow condition during a treatment.

The assembly of the seat, the valve member and the extending members can be all one piece or in discrete pieces to be assembled, although a one piece construction is preferred. The assembly can be run in within a plug or other tools that is part of a tubing string or delivered to the plug or other tool after the string with the plug or other tools is already in position in the borehole.

Since flow is possible below a predetermined flow rate the original or replacement gun does not need to be introduced with coiled tubing to be able to push the gun to the desired location. The ability to flow against packer cup seals associated with a gun at a predetermined rate avoids the need for slow and expensive alternatives such as coiled tubing.

The above description is illustrative of the preferred embodiment and many modifications may be made by those skilled in the art without departing from the invention whose scope is to be determined from the literal and equivalent scope of the claims below:

I claim:

1. A check valve for a tubular in subterranean treatment use, comprising:
a seat in the tubular having an opening therethrough;
a valve member non-releasably retained in a spaced relation to said opening in said seat up to a predetermined flow rate by force delivered from at least one flexible member extending from said seat and located peripherally to said opening;
said flexible member flexing to bring said valve member into sealing contact with said seat to close said opening when said predetermined flow rate is exceeded.

2. The check valve of claim 1, wherein:
said seat, valve member and flexible member are made of one piece.

3. The check valve of claim 1, wherein:
said seat, valve member and flexible member are made of non-metallic material.

4. The check valve of claim 1, wherein:
said at least one flexible member comprises a plurality of spaced flexible members positioned to restrain relative rotation between said valve member and said seat.

5. The check valve of claim 1, wherein:
said flexible member flexes by bending in at least one location between opposed ends thereof, said ends attached to said seat and said valve member respectively.

6. The check valve of claim 1, wherein:
said valve member having a tapered leading end that at least in part enters said opening when contacting said seat.

7. The check valve of claim 1, wherein:
said seat further comprises a sealing surface immediately surrounding said opening;
said valve member having a parallel surface to said sealing surface for circumferential contact all-around said sealing surface.

8. The check valve of claim 7, wherein:
said sealing surface further comprising a composite, single or multiple compound elastomer or a metal.

9. The check valve of claim 3, wherein:
said non-metallic comprises an elastomer.

10. A subterranean formation treatment method using the check valve of claim 1.

11. A subterranean formation treatment method comprising:
running in on a tubular string or subsequently delivering through the tubular string a check valve assembly that does not substantially move a valve member and restrict flow coming into the string when running in, said valve member permits flow out of the string up to a predetermined flow rate above which flow rate said valve member engages a seat to prevent flow out of said string;
performing a treatment when said valve member engages said seat.

12. The method of claim 11, comprising:
non-releasably supporting said valve member from said seat with at least one flexible support member.

13. The method of claim 12, comprising:
providing said valve member, seat and support member as a single piece.

14. The method of claim 12, comprising:
providing said valve member, seat and support member in a single non-metallic material.

15. The method of claim 14, comprising:
making said material an elastomer.

16. The method of claim 12, comprising:
providing a plurality of circumferentially spaced support members as said at least one support member;
retaining said valve member against relative rotation with respect to said seat when milling out said valve member.

17. The method of claim 16, comprising:
bending said support members in response to flow to store potential energy as said valve member moves toward said seat in response to flow out of said string;
releasing said potential energy to space said valve member from said seat when pressure on said valve member holding said valve member to said seat declines below a predetermined quantity;
connecting said valve member and said seat at opposed ends of said support members.

18. The method of claim 11, comprising:
delivering a perforating gun using flow out of said string at or below said predetermined flow rate;
creating openings in said tubular string for said performing a treatment.

19. The method of claim 11, comprising:
removing an initial perforating gun from said tubular string if said gun fails to fire;
delivering a redressed said perforating gun or a replacement perforating gun using flow out of said string at or below said predetermined flow rate;
creating openings in said tubular string for said performing a treatment with either gun.

20. The check valve of claim 1, wherein:
said valve member having a flat leading end that does not enter said opening when contacting said seat.
